(19) United States
(12) Patent Application Publication
(10) Pub. No.: US 2009/0079758 A1
(43) Pub. Date: Mar. 26, 2009

(54) Method and device for generating shadow maps

(75) Inventors: Thomas Annen, Saarbrucken (DE); Hans-Peter Seidel, St. Ingbert (DE); Jan Kautz, London (GB); Tom Mertens, Peer (BE)

Correspondence Address: DAVIDSON BERQUIST JACKSON & GOWDEY LLP, 4300 WILSON BLVD., 7TH FLOOR, ARLINGTON, VA, 22203, US

(73) Assignee: Max-Planck-Gesellschaft zur Forderung per Wissenschaften e.V., Munchen (DE)

(21) Appl. No.: 11/902,683

(22) Filed: Sep. 25, 2007

(51) Int. Cl. G09G 5/00

(52) U.S. Cl. 345/607

(57) ABSTRACT

A method and a device for determining shadows in a computer-generated image are provided, wherein the determination whether a pixel x is in shadow is based on a shadow test function ƒ(d(x), z(P)), d(x) representing the depth of the pixel x with respect to the light source and z(p) being a shadow map z for the computer-generated image. According to the invention, the shadow test function ƒ satisfies

$$f ( d ( x ) , z ( p ) ) = {\sum }_{i = 1}^{N} {a}_{i} ( d ( x ) ) {B}_{i} ( z ( p ) )$$

wherein aᵢ are weighting coefficients depending on d, Bᵢ are basis functions in terms of z and N is a natural number.

The present invention relates to the field of computer graphics. In particular, it relates to a method and device for generating shadow maps in computer-generated images.

### TECHNICAL BACKGROUND AND PRIOR ART

Great efforts have been made in the field of computer graphics to provide efficient solutions to visibility and shadow computation. Unfortunately, accurate shadows still demand a great amount of geometric computation, which makes them inapplicable for real-time computation.

Shadow Mapping (Williams, L.: Casting curved shadows on curved surfaces. Computer Graphics (Proceedings of SIGGRAPH '78) (1978), 270-274.) has grown into a de facto standard for rendering shadows in movie productions and video games. As it is a purely image-based approach, Shadow Mapping is robust against increased scene complexity, and translates well to graphics hardware. Shadow Maps are constructed by rasterizing a depth image from the light source's vantage point, thereby recording the distance to the closest surfaces. Any scene point can be projected into the light's view to retrieve the corresponding blocker distance. If this distance is smaller than the actual distance to the light source, the point is in shadow.

FIG. 1 illustrates the principle of shadow mapping according to the state of the art. Let \vec{x}ε [symbol] be the world space position of a pixel. Point pε [symbol] represents the position of a shadow map pixel, which is obtained via a surjective mapping T: [symbol] → [symbol] between world space and shadow map space, such that p=T(x). This mapping basically warps a pixel into Shadow Map space via a perspective projection. The Shadow Map itself encodes a function z(p), that represents the depth of the blocker that is closest to the light source for each p. A pixel with world space position x is considered in shadow when d(x)>z(p), with d(x) being the depth of x (again, with respect to the light source).

One may now formally define a shadow function s( ), that basically encodes the shadow test:

s(x):=ƒ(d(x), z(p)) (1)

where ƒ(d,z) is a binary function that returns 0 if d>z and 1 otherwise.

Unfortunately, Shadow Mapping has its problems. Since the blockers are discretized, aliasing artifacts like jagged can occur. Novel variants of Shadow Mapping have been introduced to alleviate discretization (Fernando R., Fernandez S., Bala K.: Adaptive shadow maps. In Proceedings of SIGGRAPH 2001, Computer Graphics Proceedings, Annual Conference Series, ACM SIGGRAPH, pp. 387-390; Stamminger M., Drettakis G.: Perspective shadow maps. ACM Transactions on Graphics, Proceedings of SIGGRAPH 2002, 557-562; Sen P., Cammarano M., Hanrahan P.: Shadow silhouette maps. ACM Transactions on Graphics, Proceedings of SIGGRAPH 2003), but these methods do not offer a solution for screen-space aliasing. In particular, detailed shadows may give rise to Moire patterns when viewed from far, especially as geometric complexity increases. For texture mapping, screen-space aliasing can be dealt with efficiently through high-quality filtering, which is commonly found on graphics hardware.

Unfortunately, filtering the Shadow Map's depth values does not produce the desired solution, as one wants to filter the results of the shadow test. Reeves et al. (Rendering antialiased shadows with depth maps. Computer Graphics, Proceedings of SIGGRAPH '87, 1987, page 283-291) were the first to switch the order of filtering and testing. This led to the Percentage Closer Filtering (PCF) algorithm, and is available on current graphics hardware. PCF performs filtering by taking multiple shadow samples and averaging them together. Unfortunately, it cannot support pre-filtering, and is therefore limited to small filter kernels for efficiency reasons. Mip-mapping is an efficient version of pre-filtering (Williams L.: Pyramidal parametrics. In SIGGRAPH '83: Proceedings of the 10th annual conference on Computer graphics and interactive techniques (New York, N.Y., USA, 1983), ACM Press, pp. 1-11), which fetches pre-convolved texture samples from an image pyramid and allows for effective anti-aliasing. Since the shadow test depends on the distance between the query point and the light source, which can change at run-time, this kind of pre-filtering is not possible. However, Variance Shadow Mapping (Donnelly W., Lauritzen A.: Variance shadow maps. In SI3D '06: Proceedings of the 2006 symposium on Interactive 3D graphics and games (New York, N.Y., USA, 2006), ACM Press, pp. 161-165) showed that a statistical estimate of a convolved depth test can be computed at run-time allowing for filtered shadows. Unfortunately, this estimate is biased and leads to disturbing high-frequency artifacts for scenes with high depth complexity.

It is therefore an object of the present invention to provide an improved method and device for generating shadow maps in computer-generated images that is susceptible to pre-filtering.

### BRIEF SUMMARY OF THE INVENTION

This object is achieved according to the invention by a shadow mapping method and device according to the independent claims. Advantageous embodiments are defined in the dependent claims.

The Shadow Maps of the present invention allow filtering with arbitrary convolution kernels and therefore enable the use of pre-filtering techniques for anti-aliasing. In particular, mip-mapping as well as blurring of the shadow map may be performed, i.e. of the basis functions to be more precise, in order to remove aliasing artifacts from both minification as well as discretization.

### SHORT DESCRIPTION OF THE FIGURES

FIG. 1 illustrates the basic principle of shadow mapping;

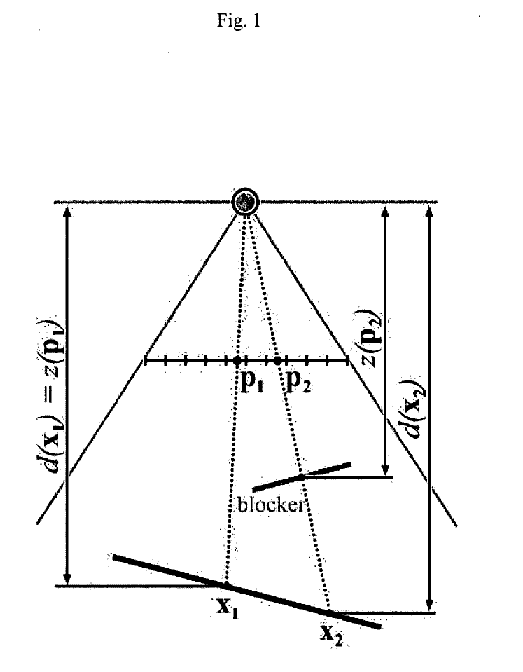

FIG. 2 depicts convolution using a filter kernel w.

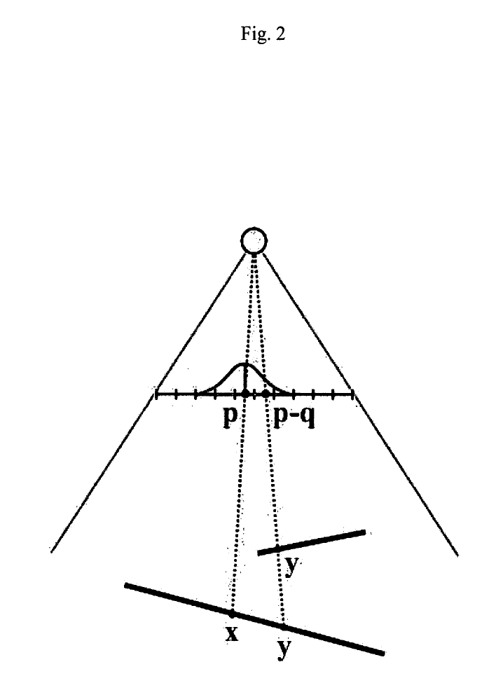

FIG. 3 illustrates the conflict of increasing M to achieve a more reliable shadow test and introducing high frequencies noticeable as ringing artifacts.

FIG. 4 shows the impact of attenuation to suppress ringing as the red turns into the blue signal.

FIG. 5 shows how an offset may be applied to d before reconstruction, which prevents incorrect darkening of lit areas.

FIG. 6 shows how scaling makes the transition steeper and how it also prevents incorrect darkening.

FIG. 7 shows (a) a simplified view of a graphics hardware pipeline according to the state of the art and (b) and (c) show different embodiments of the invention

### DETAILED DESCRIPTION OF THE INVENTION

A convolution (or linear filtering) operation on a function g with kernel w supported over a neighborhood N, is defined as:

$$[ w * g ] ( p ) \text{:} = {\sum }_{{q}^{->} ∈ N} w ( q ) g ( p - q ) \qquad ( 2 )$$

In order to apply pre-filtering to the shadow map, filtering z(p)-values must be essentially equivalent to filtering the result of the shadow test. However, the shadow test function ƒ(d,z) may not directly be convolved for linear filtering in general, because the shadow test function is non-linear with respect to its arguments.

The present invention proposes transforming the z-values such that the shadow test may be written as a sum, this allowing to “linearize” the depth test.

More specifically, ƒ(d, z) may be expanded as follows:

$$f ( d , z ) = {\sum }_{i = 1}^{∞} {a}_{i} ( d ) {B}_{i} ( z ) \qquad ( 3 )$$

Here, the Bᵢ are basis functions in terms of z. Each basis is weighted by corresponding coefficients aᵢ depending on d. In practice, the expansion has to be truncated to some truncation order N (the ≈-relation in the following formulas will be silently omitted).

It may be seen that the expansion does not yield a direct linear dependence on z, but it is linear with respect to the basis set B_{i=1 . . . N}. In order to apply this expansion in practice, the Shadow Map may be converted to “basis images” by applying each basis function to the Shadow Map: Bᵢ(z(p)). Consequently, the shadow function in Equation (1) may be translated to a linear combination of these basis images:

$$s ( x ) = {\sum }_{i = 1}^{N} {a}_{i} ( d ( x ) ) {B}_{i} ( z ( p ) ) \qquad ( 4 )$$

A linear filtering of this so-expanded shadow function by convolution with a kernel w yields

$$\begin{matrix}{s}_{f} ( x ) = [ w * f ( d ( x ) , z ) ] ( p ) \\ = [ w * {\sum }_{i = 1}^{N} {a}_{i} ( d ( x ) ) {B}_{i} ] ( p ) \\ = {\sum }_{i = 1}^{N} {a}_{i} ( d ( x ) ) [ w * {B}_{i} ] ( p )\end{matrix} \qquad ( 5 )$$

As the skilled person may readily observe, any convolution operation on the shadow function is equivalent to convolving the individual basis images Bᵢ(z(p)).

In one embodiment of the invention, the Fourier series expansion may be used to “linearize” or to expand the depth test. For clarity, it is to be noted that the Fourier expansion will not be used for applying the convolution theorem to perform spatial filtering; convolution of the basis images Bᵢ(z(p)) will be done explicitly.

In other words, the shadowing function ƒ may be expanded according to equation (3) using a Fourier series. In general, any periodic function g(t) may be decomposed as an infinite sum of waves:

$$g ( t ) = \frac{1}{2} {a}_{0} {\sum }_{n = 1}^{∞} [ {a}_{n} cos ( \frac{2 π n}{T} t ) + {b}_{n} sin ( \frac{2 π n}{T} t ) ] \qquad ( 6 )$$

wherein the coefficients aₙ and bₙ are obtained by integrating the cosine and sine basis functions against g, respectively.

The shadow test function ƒ has two arguments but it may also be expressed using the Heavyside step (or the “unit step”) function H(t) as follows:

ƒ(d, z)=H(d−z).

In order to obtain a periodic function required for applying a Fourier series approximation, the function H may be represented using a square wave function S(t) with period 2. For tε(−1,1) one obtains

$$H ( t ) = \frac{1}{2} + \frac{1}{2} S ( t )$$

For this particular case of S(t), the (truncated) Fourier series expansion yields:

$$S ( t ) \approx \frac{π}{4} {\sum }_{k = 1}^{M} \frac{1}{2 k - 1} sin [ ( 2 k - 1 ) π t ] \qquad ( 7 )$$

Therefore, for ƒ one obtains

$$f ( d , z ) \approx \frac{1}{2} + 2 {\sum }_{k = 1}^{M} \frac{1}{{c}_{k}} sin [ ( {c}_{k} ( d - z ) ) ] \qquad ( 8 )$$

wherein cₖ=π(2k−1). The previous summation may be converted into a form similar to equation (3) using the trigonometric identity

sin(a−b)=sin(a)cos(b)−cos(a)sin(b). (9)

Therefore, one obtains

$$f ( d , z ) \approx \frac{1}{2} + 2 {\sum }_{k = 1}^{M} \frac{1}{{c}_{k}} cos ( {c}_{k} d ) sin ( {c}_{k} z ) - 2 {\sum }_{k = 1}^{M} \frac{1}{{c}_{k}} sin ( {c}_{k} d ) cos ( {c}_{k} z ) . \qquad ( 10 )$$

It may be seen that equation (10) complies with equation (3) and has separable terms with respect to d and z:

$$\begin{matrix}{a}_{( 2 k - 1 )} ( d ) = \frac{2}{{c}_{k}} cos ( {c}_{k} d ) , & {a}_{( 2 k )} ( d ) = \frac{- 2}{{c}_{k}} sin ( {c}_{k} d ) \\ {B}_{( 2 k - 1 )} ( z ) = sin ( {c}_{k} z ) , & {B}_{( 2 k )} ( z ) = cos ( {c}_{k} z )\end{matrix} \qquad ( 11 )$$

with k=1, . . . ,M (note that N=2M in equation 3). The constant term ½ may be added separately.

The chosen Fourier expansion has two advantages. First, it is shift-invariant with respect to d and z, which is a general property of the Fourier transform. Intuitively speaking, this allows “moving” the Heaviside step around without any loss in precision. In fact, this may be done by independently changing d and z, while keeping the approximation error due to truncation constant. The second advantage is that the basis functions (sine and cosine waves) are bounded: they always map to the interval [−1,1]. This affords a fixedpoint representation, which may even be quantized to 8 bits in practice.

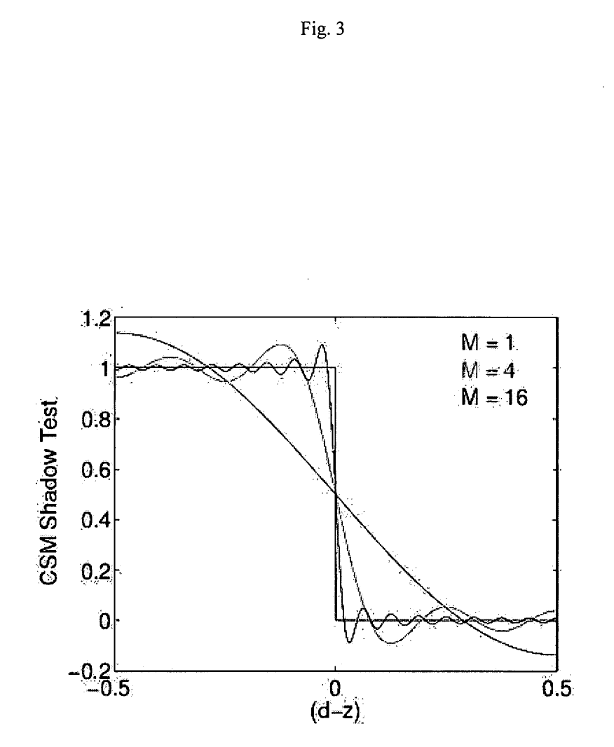

FIG. 3 illustrates the effect of increasing M to achieve a more reliable shadow test, wherein the x-axis encodes the difference (d−z) along a shadow ray (lookup) and the y-range has been scaled for illustration purposes to emphasize the effects. As the skilled person will certainly note, the Fourier expansion of the Heaviside step is increasingly subject to ringing (Gibbs phenomenon) the larger M is chosen.

In one embodiment of the invention each k-th term of the expansion may therefore be attenuated by

$$exp ( - {α ( \frac{k}{M} )}^{2} )$$

in order to deal with ringing. Parameter α controls the attenuation strength (α=0 leaves the series unchanged). The magnitude of the high frequencies is always reduced more, while the low frequencies remain almost the same.

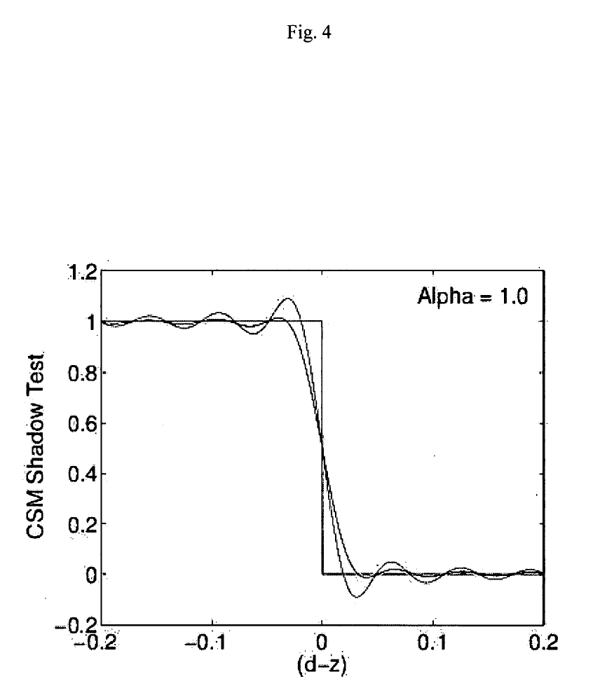

FIG. 4 shows the impact of attenuation to suppress ringing. As may be seen, this incurs an important tradeoff: reducing ringing also means that the reconstructed Heaviside step becomes less steep.

In further embodiments of the invention, the shadow test may be enhanced by applying offsets and by scaling.

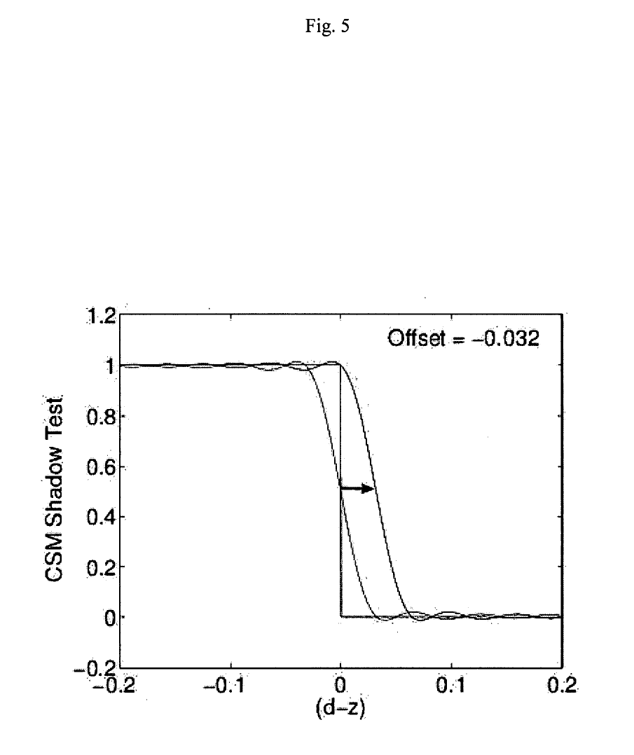

FIG. 5 shows the effect of applying an offset to d before reconstruction. The Fourier expansion of the step function introduces a smooth transition, which is especially obvious with low order expansions M, see FIG. 3. This means that for lit surfaces, where (d−z)≈0, the shadow function ƒ(d, z) evaluates to 0.5. This is undesirable, as all lit surfaces would be 50% shadowed. In a further embodiment of the invention, this may be corrected by offsetting the expansion of the Heaviside step, as shown in FIG. 5. After offsetting, ƒ(d, z) goes through 1 for (d−z)≈0, which results in correctly lit surfaces. The shift-invariance property of the Fourier expansion allows formulating a constant offset, which only depends on the truncation order and can thus be applied at every pixel. Of course, offsetting makes the transition from unshadowed to shadowed more obvious near contact points.

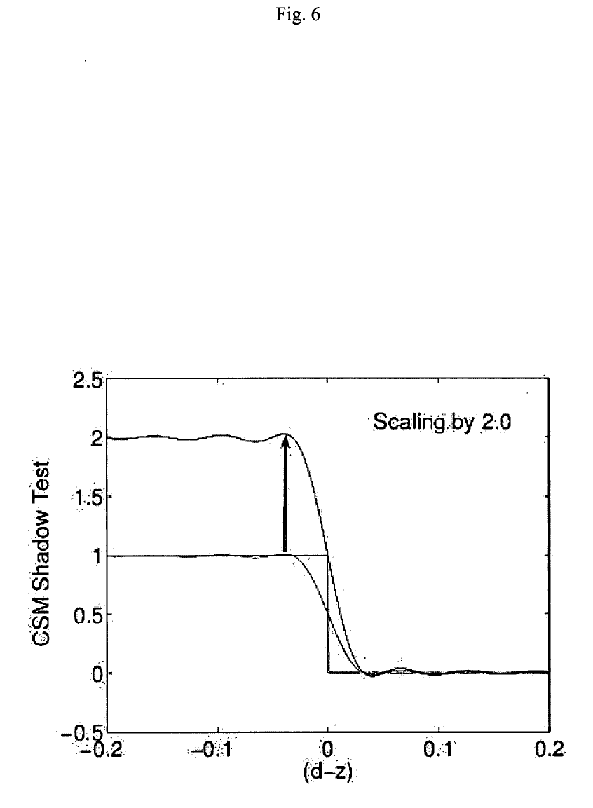

FIG. 6 shows the effect of scaling the used expansion. In a further embodiment of the invention, scaling may render the transition of the reconstructed step function steeper and may also ensure that all lit surfaces (around d−z≈0) are actually correctly lit, thereby preventing incorrect darkening.

Implementation

The so-defined Shadow Maps require only a few modifications to the standard shadow mapping pipeline. After rendering the depth values from the light's point of view, the basis functions sin(cₖz) and cos(cₖz), see equation (11), may be evaluated using the current z-values at each texel and the result may be stored, which correspond to the basis functions Bᵢ(z(p)) from equation (4) in texture maps. Linear depth values may be used to increase the sampling precision.

Depending on the Fourier expansion order M and hardware capabilities, multiple rendering passes may be performed to convert a single shadow map into a set of sine and cosine textures. For example, with M=16 one needs to generate 16 sine and also 16 cosine terms which may be packed into four sine and four cosine 8-bit RGBA textures.

When applying the invention in practice, 32-bit floating precision does not produce noticeable differences and 8-bits fixed point may be used for all renderings. With four Multiple Rendering Targets (MRTs) only two additional render passes are necessary. Each pass renders a screen-align quad and computes the sine and cosine terms based on the current shadow map respectively. Results are packed into four RGBA textures simultaneously.

Once this set of basis textures has been computed, filtering may be applied to it. First, a separable Gaussian filter kernel may be applied on the textures to hide aliasing from discretization. Of course, for high-resolution shadow maps, this is not necessary. Then, a mip-map may be built of this texture (using the auto-mip-map feature of modern graphics processing units) to prevent minification aliasing of shadows.

During the final rendering from the camera view, regular shadow mapping (either binary or PCF) may be replaced with the shadow reconstruction according to the invention. In other words, a weighted sum may be evaluated at each pixel of the filtered basis functions multiplied by coefficients aᵢ(d) (defined in equation 11), where d is the distance from the current pixel to the light source. The resulting value s_{f} (see equation 5) is the filtered shadow value. Simply switching on mip-mapping or even anisotropic filtering removes screen-space aliasing; no shader magic is needed. Due to ringing, the resulting shadow value can be outside the [0, 1]-range and therefore the result may be clamped to lie within [0, 1].

In a further embodiment of the invention, the shadow test function may also be chosen such that it satisfies

ƒ(d(x),z(p))=e^{-c(d(x)-z(p))} (12)

with c>0.

This exponential function may be used, because it also complies with the general form of equation 4. Indeed, the exponential function is separable w.r.t. d and z:

$$\begin{matrix}f ( d , z ) = {e}^{- c ( d - z )} \\ = {e}^{- c d} {e}^{cz}\end{matrix} \qquad ( 13 )$$

In order to see that the alternative shadow test function is also linear with respect to the exponential basis, one may again consider a linear filtering of this alternative shadow function by convolution with a kernel w:

$$\begin{matrix}{s}_{f} ( x ) = [ w * f ( d ( x ) , z ) ] ( p ) \\ = [ w * {\sum }_{i = 1}^{∞} {a}_{i} ( d ( x ) ) {B}_{i} ( z ) ] ( p ) \\ = [ w * ( {e}^{- c d ( x )} {e}^{cz} ] ( p ) \\ = {e}^{- c d ( x )} [ w * {e}^{cz} ] ( p )\end{matrix} \qquad ( 14 )$$

A growing parameter c yields an increasingly better approximation of the shadow test, and turns into an equality when c→∞.

The choice of this alternative shadow test is based on the observation that in a large number of cases, it may be assumed that for a given point x seen be the camera, whose corresponding point p lies within the shadow map, the difference d(x)−z(p) does not become negative when pre-filtering. As the function to be approximated is then really a step down from zero, the simple exponential decay function may be used as defined above. In particular, this assumption always holds in the case of nearest neighbor sampling.

In cases where this assumption is violated, a custom filtering may be performed. In practice, such cases may be recognized, e.g. when the shadow test function exceeds a particular value, e.g. when the shadow test function exceeds 1.1. In one embodiment of the invention, the custom filtering may comprise taking four samples s₁ to s₄ from the shadow map and using the following value:

(e^{-cd}*s₁+e^{-cd}*s₂+e^{-cd}*s₃+e^{-cd}*s₄)/4.0

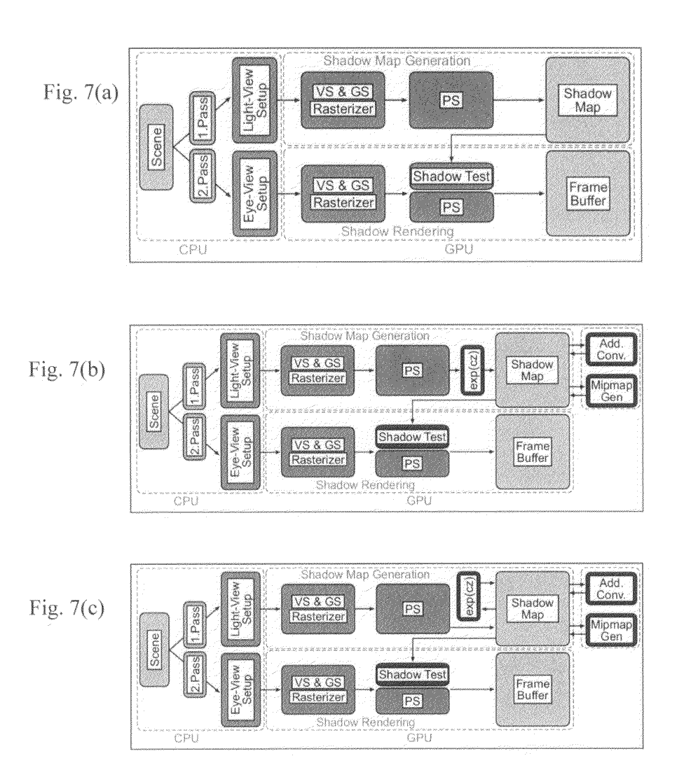

FIG. 7a illustrates a simplified overview of the most important parts of a modern graphics chip involved in Shadow Mapping. First, the scene is rendered from the light source view, and transformed by the vertex—(VS) and potentially the geometry shader (GS). Then, triangles are set up for rasterization and the pixel shader (PS) operates on the individual fragments before they are written to a dedicated shadow map memory. During the final rendering pass similar processing happens but now with respect to the camera/eye view. Currently, pixel shaders support shadow texture samplers which return a bilinearly filtered (PCF) shadow tests and results in a properly attenuated shadow value for the current pixel.

In order to integrate the present invention into this hardware, the creation of the shadow map may be modified. The final rendering pass, where the shadow map is used to generate shadows, maybe executed trivially in a pixel shader and standard high-quality texture filtering.

FIG. 7b shows how, in one embodiment of the invention, the write-out of z-values into a depth texture may be modified. Instead of writing plain hyperbolic or linearized z-values graphics hardware applies the exponential function e^{cz} of equation 12. For shadow rendering an explicit shadow test and subsequent filtering of results as for PCF is then only needed for a very sparse subset of pixels. Rendering shadows with ESMs becomes a multiplication of two exponential terms: the exponential distance from the light source to the blocker (e^{cz(p)}) which is stored in an ESM and the exponential distance from the point to be shaded to the light source (e^{-cd(x)}). After the exponential shadow map is available, hardware can optionally apply additional convolutions ([w*e^{cz}](p)) to further band-limit the signal and finally trigger mip-map generation to support trilinear filtering. Simple pre-defined convolution kernels (e.g. a 3×3 or 5×5 separable Gauss) may be provided for programmers.

Generating the shadow map requires the depth test to be active to ensure that only the closest blockers are stored.

FIG. 7c shows how in an alternative implementation, the hyperbolic z-values may be kept until rendering the shadow map has been finished. Then, an additional internal pass may convert the depth texture to its exponential version. The shadow test functionality may remain the same as described in relation to FIG. 7b.

An advantage of this approach is that the depth test and numerical precision is not affected by the ESM basis conversion. An additional benefit is that pre-filtering and optional convolutions may be done in this pass as well. Also, the number of evaluations of the exponential function only depends on the shadow map resolution, whereas the previous scenario requires an evaluation for every candidate fragment, which may be costly for a scene with high depth complexity.

The parameter c may be set by the manufacturer of the graphics processing unit (GPU) according to the highest value possible without producing numerical overflows. This decision has to take pre-filtering and additional convolutions into account. In that context, it is also noted that d−z may be clamped to [0,1] to restrict the domain of the shadow test and therefore a conservative estimation of c is possible.

We claim:

1. Method for determining shadows in a computer-generated image, wherein the determination whether a pixel x is in shadow is based on a shadow test function
ƒ(d(x), z(p)),
d(x) representing the depth of the pixel x with respect to the light source and z(p) being a shadow map z for the computer-generated image, characterized in that the shadow test function f satisfies
$$f ( d ( x ) , z ( p ) ) = {\sum }_{i = 1}^{N} {a}_{i} ( d ( x ) ) {B}_{i} ( z ( p ) )$$
wherein
aᵢ are weighting coefficients depending on d,
Bᵢ are basis functions in terms of z and
N is a natural number.

2. Method according to claim 1, wherein the shadow test function ƒ satisfies
$$f ( d ( x ) , z ( p ) ) = \frac{1}{2} + 2 {\sum }_{k = 1}^{M} \frac{1}{{c}_{k}} cos ( {c}_{k} d ( x ) ) sin ( {c}_{k} z ( p ) ) - 2 {\sum }_{k = 1}^{M} \frac{1}{{c}_{k}} sin ( {c}_{k} d ( x ) ) cos ( {c}_{k} z ( p ) )$$
wherein cₖ=π(2k−1).

3. Method according to claim 2, wherein each k-th term is attenuated by
$$exp ( - {α ( \frac{k}{M} )}^{2} )$$
wherein α controls the attenuation strength.

4. Method according to claim 1, wherein the shadow test function ƒ satisfies
ƒ(d(x),z(p))=e^{-c(d(x)-z(p))}
with c>0.

5. Method according to claim 1, wherein an offset is applied to d(x).

6. Method according to claim 1, wherein the shadow test function is scaled.

7. Method according to claim 1, wherein mip-mapping is applied to the basis functions.

8. Method according to claim 1, wherein blurring is applied to the basis functions.

9. Graphics processing device, comprising
means for determining shadows in a computer-generated image, wherein the determination whether a pixel x is in shadow is based on a shadow test function
ƒ(d(x), z(p)),
d(x) representing the depth of the pixel x with respect to the light source and z(p) being a shadow map z for the computer-generated image, characterized in that the shadow test function ƒ satisfies
$$f ( d ( x ) , z ( p ) ) = {\sum }_{i = 1}^{N} {a}_{i} ( d ( x ) ) {B}_{i} ( z ( p ) )$$
wherein
aᵢ are weighting coefficients depending on d,
Bᵢ are basis functions in terms of z and
N is a natural number.

10. Graphics processing device according to claim 9, further comprising means for applying the exponential expansion e^{cz(p)} to the shadow map z(p).

11. Graphics processing device according to claim 10, further comprising means for applying additional convolutions
[w*e^{cz}](p)
to the transformed shadow map using convolution kernels w.

12. Computer-readable medium, storing instructions that, when executed on a computer, implement a method according to claim 1.
